(19) United States
(12) Patent Application Publication
(10) Pub. No.: US 2025/0373289 A1
(43) Pub. Date: Dec. 4, 2025

(54) System and Method for Structural Communication

(71) Applicant: OLEKSANDR KOROSTYLOV, BARRIE (CA)

(72) Inventor: OLEKSANDR KOROSTYLOV, BARRIE (CA)

(21) Appl. No.: 19/224,465

(22) Filed: May 30, 2025

Related U.S. Application Data
(60) Provisional application No. 63/653,277, filed on May 30, 2024.

(51) Int. Cl. H04B 7/0456; H04L 9/40

(52) U.S. Cl. CPC H04B 7/046; H04B 7/0482; H04L 63/06

(57) ABSTRACT

A system and method for structural communication wherein semantic content is embedded within transmitted signals through algebraic structuring is provided. The system comprises a dual-directional flow of information between raw physical signals (Level-A) and structured algebraic representations (Level-B), enabling semantic-level communication over noisy or distorted channels. Transmitters encode data as algebraic identities over group algebras, which are then converted into modulated signals. Receivers jointly decode the transmitted signal and infer both the underlying algebraic structure and any signal distortions, without requiring pilot signals or traditional error correction. The system provides robust noise resilience, signal integrity awareness, source separation through algebraic multiplexing, and integrated channel and semantic estimation. Algebraic structures can be modulated to encode secondary information, and the system supports variability and invariance in signal representations.

### CROSS-REFERENCE TO RELATED APPLICATIONS

This application claims the benefit of pending U.S. Provisional Patent Application No. 63/653,277, titled “System and Method for Optimizing Number Systems”, filed on May 30, 2024, the entirety of which is incorporated herein by reference.

### BACKGROUND OF THE INVENTION

The present invention relates generally to communication systems and signal processing, and more particularly to systems and methods for transmitting semantically structured information using algebraic representations. Specifically, the invention pertains to structural communication techniques that encode semantic content into signals using finite group algebras, enabling robust, bidirectional communication over noisy or distorted channels without reliance on conventional error-correction coding or channel probing.

Historically, the theory of communication and artificial intelligence (AI) have evolved along largely separate paths. Communication theory has primarily focused on the transmission of raw bits and symbols with maximum fidelity and efficiency. In this traditional model, information is treated as abstract data to be encoded, modulated, transmitted, and decoded-without regard to the meaning that data might carry. The primary concern has been ensuring accurate delivery of signal content in the face of noise and distortion.

However, the field of artificial intelligence, and especially machine learning (ML), is fundamentally concerned with meaning. AI models are typically designed to extract, infer, or generate semantically rich representations from input data. These systems often operate on high-level abstractions, such as categories, latent features, or contextual relationships. These semantics are removed from the low-level binary data manipulated in classical communication systems. This dichotomy between the two fields reveals a conceptual divide between two levels of abstraction in the communication process. These layers are generally grouped into three distinct levels. “Level A” is the technical level which deals with how accurately symbols can be transmitted. “Level B” is called the semantic level. It deals precisely the transmitted symbols convey the intended meaning. “Level C is the effectiveness level. Level C deals with how effectively the received meaning influences the receiver's behavior or understanding.

Modern communication systems overwhelmingly operate at Level A, while AI and machine learning are concerned with Level B and, to a lesser extent, Level C. However, there has been increasing interest in bridging this gap. As AI systems become embedded in communication contexts (e.g., intelligent assistants, autonomous agents), and as communication protocols seek to carry higher-order meanings (e.g., intent, classification, context), the need for unified treatment of all levels becomes more urgent.

This convergence has given rise to a growing research area known as semantic communication, particularly in the context of next-generation standards such as 6G. Despite growing momentum in the area of semantic communication, the field remains without a rigorous technical or mathematical definition of “meaning” or “semantics” that can be embedded, transmitted, and recovered through standard communication protocols. Nonetheless, there are commonly accepted expectations about what a semantics-aware communication system should enable.

A semantics-aware communication system should exhibit several core properties that enable the reliable transmission and recovery of meaning through noisy or distorted channels. First, the system should provide noise robustness and integrity awareness. This means that the presence of a structured semantic layer within the transmitted signal ensures internal redundancy and consistency, allowing the receiver to detect and correct errors, reconstruct missing information, and assess the logical integrity of the received data. This supports continued communication reliability even when the channel is impaired by noise or data corruption.

Second, the system should enable multiplexing and source separation, allowing multiple distinct semantic signals to be transmitted simultaneously over a shared communication medium. By embedding a unique semantic structure into each transmission, the system makes it possible for the receiver to disentangle overlapping signals and correctly attribute received components to their respective sources.

Third, the system should facilitate distortion identification and compensation. Unlike random noise, certain distortions introduced by the channel, such as systematic transformations, time shifts, or parametric deformations can be modeled and understood. A properly structured signal can support the joint inference of both the semantic structure and the distortion model, allowing the receiver to recover the intended meaning or even extract valuable information about the channel itself.

Fourth, a semantically structured system should demonstrate variability and invariance. A single semantic meaning (Level-B structure) should be capable of being represented through multiple different physical forms (Level-A signals), offering encoding flexibility. At the same time, the receiver should be able to recognize the invariant underlying structure despite superficial variations in the signal's expression.

Finally, the system should support intelligent communication, in which the primary objective is not merely the accurate delivery of raw symbols, but the faithful transmission and recognition of structured semantic meaning. This capability enables higher levels of abstraction, where the communication system effectively bridges the gap between machine understanding and physical signal transmission

TABLE 1
Capabilities of Communication Algorithms and Recognition Systems

| | Example index | | | | | | | | |
|---|---|---|---|---|---|---|---|---|---|
| | | 2 | | 4 | | 6 | | | |
| | 1 | Error | 3 | MIMO | 5 | QR | | 8 | |
| Example | Hough | correcting | Joint | Beam | Beam | codes | 7 | Semantic | This |
| name | transform | codes | estimation | forming | Search | (layout) | ASR | communication | invention |
| Integrity | −+ | + | + | −+ | −+ | + | −+ | −+ | + |
| awareness | | | | | | | | | |
| Noise | +− | + | + | + | + | + | +− | +− | + |
| robustness | | | | | | | | | |
| Multiplexing | + | | | + | | | | | + |
| source | | | | | | | | | |
| separation | | | | | | | | | |
| Distortions | | | + | | | + | | | + |
| identification | | | | | | | | | |
| Variability | + | | | (+) | | | | +− | + |
| Invariance | + | | | (+) | −+ | | +− | +− | + |
| Intelligent | + | | | (+) | | | −+ | rare | + |
| communication | | | | | | | | | |

Legend:
empty cell—property is absent
+—property is present to a decent degree
−+—property is present to a low degree
+−—property is present to some degree
(+)—property could be considered as present but it is not an intended use case

As shown, existing methods each address a subset of the desired properties but fall short of achieving a complete integration of semantic and signal-level communication. Some, like joint channel and data estimation techniques or error-correcting codes, provide robustness and integrity checks but focused on data transmission rather than structures transmission and are not inherently semantic. Beamforming captures aspects of signal separation but does not promote the structures themselves to its objects of interest. Beam search and ASR systems capture aspects of contextual inference but do not have explicit computational model for semantics and integrity. Even advanced neural network-based semantic communication systems often have approximate meanings through statistical correlation rather than structural representation, leaving them weak in terms of generalization and brittle under distortion or adversarial conditions.

This invention provides a novel framework for structural communication that realizes all five desirable properties simultaneously. It introduces a technical mechanism by which semantic information-formally expressed as algebraic structures—can be encoded into transmitted signals and recovered through joint inference at the receiver. In contrast to graph-based or latent vector representations commonly used in AI systems, the present invention uses algebras of numbers, specifically finite group algebras, to serve as the carriers of semantic content.

Rather than transmitting explicit symbols (e.g., nodes and edges in a graph), the invention encodes algebraic identities (formulas and expressions that are satisfied within a specific group algebra). On the receiver side, the system solves an inverse problem: it uses the received, possibly distorted identities to identify the algebraic structure that makes them collectively consistent. The structure of the algebra is itself the message, and the method of transmission enables bottom-up inference from signal to meaning (Level A to B) and top-down justification from meaning to signal (Level B to A). This duality enables error correction, signal separation, structure recognition, and channel estimation to be addressed in a unified process.

In light of the systems and methods disclosed in the known art, it is submitted that the present invention substantially diverges in design elements and methods from the known art and consequently it is clear that there is a need in the art for an improvement in systems and methods that address the problem of transmitting, recovering, and utilizing semantically structured information through robust, noise-resilient, and distortion-aware communication frameworks. In this regard the instant invention substantially fulfills these needs by introducing a technical framework for structural communication based on the transmission of algebraic identities and identification of algebras.

### SUMMARY OF THE INVENTION

In view of the foregoing disadvantages inherent in the known systems and methods for communicating and decoding semantically meaningful information now present in the known art, the present invention provides a system and method for structural communication by embedding structure representations into transmitted signals using algebraic identities over group algebras.

It is an objective of the present invention to provide a system and method for transmitting structured semantic information through physical communication channels using group algebra-based encoding.

It is another objective of the present invention to provide a transmitter and receiver system in which algebraic identities, satisfiable in finite group algebras, are used to encode and decode structured information.

It is yet another objective of the present invention to enable joint decoding of both the semantic structure and signal distortions, without the need for pilot signals or traditional error correction codes.

It is a further objective of the present invention to introduce a system that supports signal integrity awareness, multiplexing and source separation, distortion identification, and semantic-level variability and invariance through algebraic structuring.

It is an additional objective of the present invention to allow modulation of algebraic structures to carry secondary information, and to support secure communication through key-dependent encoding of structured signals.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a diagram of an embodiment of the structural communication system, including a transmitter, receiver, shared secret key, and optimization loop with top-down and bottom-up signal flow.

FIG. 2 shows a diagram of an embodiment of the structural communication system, including a transmitter, receiver, shared secret key, and optimization loop with top-down and bottom-up signal flow.

FIG. 3a shows a diagram of an embodiment illustrating how a secret key or RNG seed influences the generation and decoding of algebraic identities on the transmitter side.

FIG. 3b shows a diagram of an embodiment illustrating how a secret key or RNG seed influences the generation and decoding of algebraic identities on the receiver side.

FIG. 4 shows a diagram of an embodiment illustrating multiplexed transmission of structured signals in a shared communication channel and means of disambiguation on the receiver side in case of MIMO.

FIG. 5 shows an embodiment illustrating shared media structural communication and enhanced source separation functionality due to algebraic multiplexing.

FIG. 6a shows a visual illustration of an embodiment comparing structured and unstructured signals under distortion, demonstrating the robustness of structured communication.

FIG. 6b shows a visual illustration of an embodiment comparing structured and unstructured signals under distortion, demonstrating the robustness of structured communication.

FIG. 6c shows a visual illustration of an embodiment comparing structured and unstructured signals under distortion, demonstrating the robustness of structured communication.

FIG. 7 shows a diagram of an embodiment in which different algebraic structures are selected over time to encode data through structure variation.

FIG. 8 shows a diagram of an embodiment demonstrating the encoding of secondary information by applying controlled distortions to a fixed algebraic structure.

FIG. 9 shows a diagram of an embodiment illustrating the encoding of information by varying parameters of a single algebraic structure over time.

FIG. 10 shows a flowchart of an embodiment illustrating the encoding of binary data into permutations of a group algebra multiplication table and the corresponding decoding process.

FIG. 11 shows a diagram of an embodiment of the joint identification of structure and its alterations.

### DETAILED DESCRIPTION OF THE INVENTION

Reference is made herein to the attached drawings. For the purpose of clearly describing the present invention, embodiments will be discussed as they relate generally to structural communication systems that encode and decode information using algebraic identities over group algebras. The figures are intended for illustrative purposes only and should not be considered limiting in any respect.

Reference will now be made in detail to exemplary embodiments of the invention. References to “one embodiment,” “an embodiment,” “at least one embodiment,” or “for example,” indicate that a particular configuration, feature, or step is included in at least one example of the invention. However, such references do not necessarily refer to the same embodiment and do not exclude other embodiments from including the described feature.

As used herein, the term “Level-A signal” refers to a modulated, physical-layer signal for transmission, subject to noise, distortion, or interference.

The term “Level-B signal” or “Permuted Group Algebra Multiplication Table (PGAMT)” refers to the structured semantic representation embedded within the Level-A signal. A group algebra multiplication table can be permuted according to a permutation of group elements, and this PGAMT itself is considered the Level-B signal.

As used herein, the term “Level-B modulation, distortion, deformation” refers to the use of a metric matrix, denoted as [Ro], that modifies the group algebra multiplication operation. For example, a product (Σxiei)·(Σyjej) would be computed as Σ(roij·ei·ej·xi·yj) over indices i and j.

As used herein, the term “Level-A representation” of a Level-B signal (which may be modulated at Level-B) is a system of identities satisfiable in the algebra defined by the PGAMT. This system has an algebraic form and numeric (real or complex valued) coefficients. The form can be predefined and fixed or controlled by a Random Number Generator (RNG) seed. Similarly, the numeric coefficients can be predefined, fixed, or controlled by an RNG seed. The system can include multiple instances of identities of the same form but with different coefficients. For any given identity, a subset or all of its coefficients can be chosen to represent it during the transmission process. For example, for an equation X·Y=Z, the set of coefficients {zk} (for k from 1 to n) can be chosen for transmission. The non-transmitted coefficients (in this example, {xi} and {yj} for i,j from 1 to n) must be restorable on the receiver side based on knowledge of the scheme used to create the system of identities.

As used herein, the term “Level-A modulation, distortion, deformation” refers to a deliberate or unavoidable alteration of the identity coefficients or of the channel signal itself. This type of modulation is aligned with classical Level-A communication scenarios.

As used herein, the term “Transmission scheme” describes how the system of identities is formed and what coefficients are transmitted. This includes any RNG seeds used, the forms of identities employed, the number of identities, any implied ordering of identities, which coefficients are transmitted versus generated from seeds, and the size and library (family) of groups expected for transmission. If a subset of all possible permutations of order n is used for PGAMTs, the scheme also specifies which group elements are to be considered fixed. The transmission scheme allows a receiver to focus on a specific transmission session; not knowing the scheme makes it impossible to receive the data.

As used herein, the term “Channel modulation” is the process of converting the chosen coefficients for an identity into a channel-compatible signal. This is performed separately for each identity and implies the existence of a channel demodulation process capable of restoring the original coefficients.

As used herein, the term “objective function” or simply “objective,” when related to optimization procedures, refers to a scalar function or criterion to be maximized or minimized, encompassing single or multi-objective scenarios and reflecting metrics like reconstruction accuracy, identity satisfaction measures, communication fidelity, transmission efficiency, noise robustness, or semantic interpretability.

As used herein, the terms “Artificial Intelligence (AI)” and “Machine Learning (ML)” refer broadly to computational systems, algorithms, or models capable of learning from and adapting to data without explicit human programming for each decision. AI and ML models include, but are not limited to, supervised learning models, unsupervised learning models, reinforcement learning models, generative models such as variational autoencoders (VAEs), diffusion models, and other neural network architectures known in the art.

As used herein, the term “generative artificial intelligence model” means a computational model, such as a variational autoencoder (VAE), or diffusion model, that synthesizes structured representations suitable for transmission. Such generative models may include, but are not limited to, variational autoencoders, generative adversarial networks, diffusion-based generative models, transformer-based generative models, and other suitable neural architectures or probabilistic frameworks known to those skilled in the art. These models may be used at the transmitter to encode identity coefficients into transmittable signals, and at the receiver to recognize or decode them. They may replace classical modulation and demodulation schemes like OFDM, ASK, PSK, etc.

The term “group algebra” refers to a mathematical construct in which elements of a finite group are linearly combined using scalar coefficients from a number field (e.g., real or complex numbers). A group algebra is defined by a set of basis elements and a binary operation satisfying closure, associativity, identity, and inverse properties. This structure allows the expression of complex relationships and identities that can carry semantic content.

A “group algebra-based signal structure” refers to a representation of information in which semantic content is encoded via a system of algebraic identities over group elements, prior to physical modulation for transmission. These identities may be expressed in various forms, including simple products, linear combinations, polynomial equations, trigonometric functions, exponentiation and logarithm functions, or even neural-network-inspired compositions. The term “algebraic identity” refers to an equation that is satisfied within a specific group algebra, such as a multiplication relation or a higher-order polynomial expression involving group elements and numeric coefficients. The multiplication operation makes algebras different from vector spaces and the identities considered here must exploit this operation.

As used herein, “controlled distortion” or “modulation” refers to the deliberate variation of the Level-A signal, including changes to amplitude, phase (in case of wave based encoding), changes to color, other optical/visual effects (in case of visual channel), or structural coefficients of Level-B signal, for the purpose of encoding secondary information. These modulations are distinguishable from channel-induced distortions, and the system is configured to jointly infer both.

The term “objective function”, in the context of receiver-side decoding, refers to a scalar function that measures the identities violation metrics when they are based on observed (possibly distorted) signal coefficients, current numeric approximation of group algebra elements and distortion model parameters. The objective function also includes regularization terms. This function is minimized to jointly recover the transmitted structure and identify any distortions.

As used herein, “multiplexing” or “structural multiplexing” refers to the simultaneous transmission of multiple structured signals, distinguished by their underlying algebraic identity or encoding parameters, over a shared communication medium. This enables source separation at the receiver even in overlapping or congested channel environments.

The term “integrated sensing” refers to the extraction of channel characteristics, environmental parameters, or distortion models directly from the received signals, without requiring explicit pilot or calibration data. This functionality leverages the embedded algebraic structure to perform joint decoding and sensing.

As used herein, the term “Joint optimization” is a process that searches for a PGAMT jointly with the identification of parametric models of Level-B and/or Level-A deliberate modulations or unavoidable channel distortions. If the modulation/distortion is of separate interest, the found PGAMT can be excluded from optimization due to its available symbolic form. Thus, a system can run a “tightening step” by excluding numeric approximate values of ei from the identities and replacing them with exact symbolic computations. This tightening step allows for more accurate estimation of modulations and distortions. The term “joint optimization” as used herein includes the initial optimization and this optional tightening step.

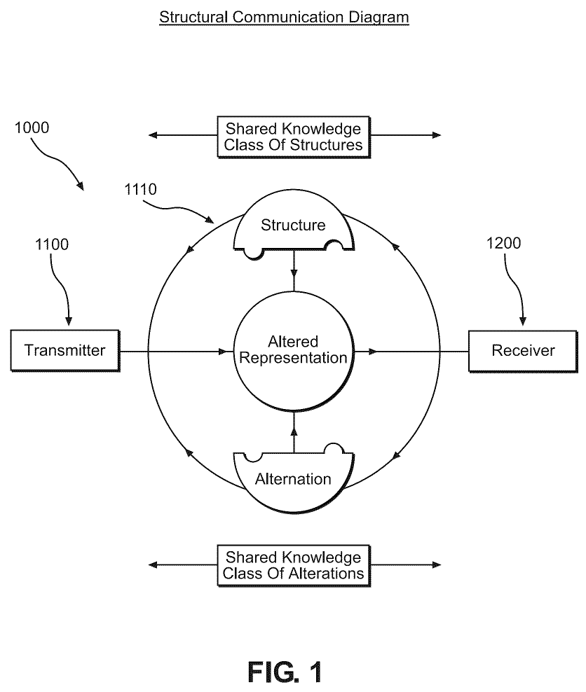

Referring now to FIG. 1, a principal diagram illustrates the core concepts of this structural communication framework. The diagram shows a communication pathway between a transmitter and a receiver proceeding through a channel. Central to this framework is the use of “Shared Knowledge,” which may include a predefined “Class of Structures” (e.g., a family of permissible group algebras or their characteristics) and a “Class of Alterations” (e.g., known types of Level-B or Level-A modulations).

FIG. 1 shows that information can be conveyed through one or more distinct but potentially concurrent pathways. First, information can be encoded in the selection of a specific “Structure” itself. In the context of this invention, this “Structure” corresponds to a Level-B signal, such as a particular Permuted Group Algebra Multiplication Table (PGAMT), chosen by the transmitter 1100 from the agreed-upon class of structures. The identity of this chosen structure, when recognized by the receiver, constitutes a primary form of communicated information.

Second, information can be encoded via “Structure Alteration.” This pathway refers to deliberate modifications made to the fundamental algebraic characteristics of the chosen Level-B structure. Such alterations correspond to Level-B modulations, for example, through the application of an Ro matrix that systematically changes the rules of the group algebra multiplication operation. The receiver, aware of the potential class of alterations, can decode this secondary information by identifying how the base structure has been modified.

Third, information can be encoded through “Altered Representation” of the structure. This involves changes to a Level-A signal for physical transmission. This pathway includes Level-A modulations, such as systematic variations in the numerical coefficients of the algebraic identities representing the structure, or modifications to the physical waveform characteristics of the signal sent through the channel. The receiver decodes this information by analyzing how the expected Level-A representation deviates from a baseline or known pattern, in conjunction with understanding the underlying Level-B structure.

These distinct pathways, individually or in combination, allow for a versatile and information-rich communication system. The transmitter selects and prepares the structure and any alterations based on the input data and the shared knowledge. The receiver utilizes its copy of the shared knowledge to interpret the received signals, disentangle the different forms of encoded information, and recover the intended message.

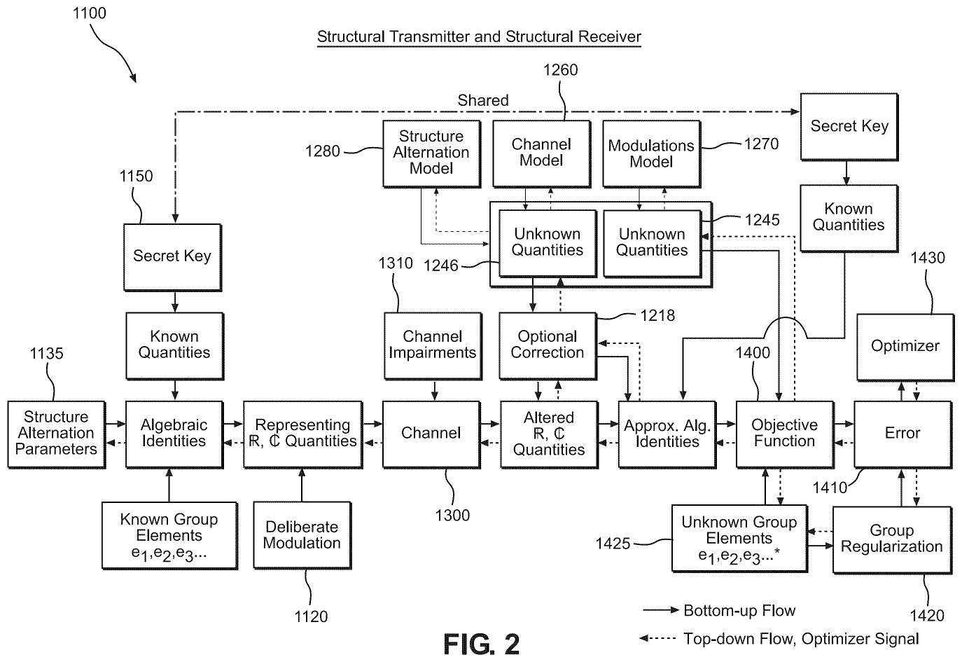

Referring now to FIG. 2, there is shown a diagram of an embodiment of a structural communication system 1000 comprising a transmitter subsystem 1100, a communication channel 1300, and a receiver subsystem 1200. The system enables the transmission and recovery of structured information that is represented as algebraic identities defined over finite group algebras. These identities are embedded within physical-level modulated signals (Level-A) and decoded through a joint inference process that simultaneously recovers both semantic structure (Level-B) and channel distortions.

In the shown embodiment, the transmitter 1100 includes an encoder, to convert input data into a Level-B signal representation comprising algebraic identities over a selected group algebra. The group algebra is typically defined by a multiplication table over a finite group of size n (e.g., n=17). The group's algebraic structure is defined by products of group elements such that e_i*e_j=e_k. These products participate in the algebraic identities. A optional secret key 1150 seeds a random number generator (RNG), which governs both the choice of forms of identities and their coefficients.

In one embodiment, encoder 1110 generates structured representations by forming algebraic identities, such as X*Y=Z, where:

$$X = x\_ 1 ⋆ e\_ 1 + x\_ 2 * e\_ 2 + … + x\_n * e\_n ,$$

$$Y = y\_ 1 ⋆ e\_ 1 + y\_ 2 * e\_ 2 + … + y\_n * e\_n ,$$

$$Z = z\_ 1 ⋆ e\_ 1 + z\_ 2 * e\_ 2 + … + z\_n * e\_n .$$

The coefficients x_i, y_i, and z_i are real or complex numbers and x_i, y_i are deterministically generated based on the secret key, and z_i are computed based on them. The encoder generates m such identities (e.g., 200), each corresponding to a time segment (e.g., 50 milliseconds). These Level-B signal representations are passed to a signal modulator 1120, which maps each identity into a Level-A physical signal using a modulation scheme such as amplitude-phase modulation. For modulation, each e_k is associated with a frequency f_k (e.g., from 500 Hz to 2200 Hz). A complex coefficient z_k is mapped to amplitude a_k and phase p_k, producing a sinusoidal component: s_k (t)=a_k*sin (2*π*f_k*t+p_k). The full signal for one identity is the sum over all k of s_k (t). The signal modulator 1120 combines all components to form a waveform for each identity. The resulting Level-A signal is transmitted through the communication channel 1300.

In some embodiments, a structure alteration parameter subsystem 1135 is included within the transmitter 1100. This subsystem is configured to deliberately introduce controlled distortions or variations into the algebraic identities generated by encoder 1110. These modifications allow the transmission of secondary information alongside the primary structured message, without impairing the recoverability of the original Level-B semantic structure. Controlled distortions may include adjustments to amplitude, phase, coefficient weighting, or structural form, all of which remain decodable due to the algebraic consistency of the group framework.

In another embodiment, the transmitter may also include a generative AI synthesis module that constructs Level-A signals using learned generative models, such as variational autoencoders (VAEs), denoising autoencoders, transformer-based models, or diffusion-based models. These models enable the synthesis of Level-B signal representations compatible with physical transmission medium that are more advanced than hand crafted channel modulation schemes 1300.

In some embodiments, the considered abelian or prime order group algebras. These are especially convenient for their simple and efficient numeric representations. In some embodiments, the selected group algebra is a finite non-abelian group algebra, allowing for increased expressiveness and structural complexity. Portions of the input data may be directly mapped to specific basis elements of this group. This enables flexibility in semantic alignment between the source data and the algebraic representation.

In one embodiment, the channel 1300 represents an acoustic or electromagnetic medium subject to real-world impairments, such as reflections, noise, analog-digital conversion effects, and clock drift. These real-world impairments alter the amplitude and phase of the transmitted coefficients. Unlike conventional systems that rely on pilot tones or external synchronization signals, the invention infers these distortions jointly with semantic content using the structural redundancy of the transmitted identities. The resulting encoded and potentially modulated signal is transmitted across the physical communication channel 1300, which may be subject to various impairments 1310, including multipath reflections, amplitude attenuation, frequency offsets, clock drift, and environmental noise.

On the receiver side 1200, the structured Level-A signals, potentially altered by the channel or intentionally modulated, are received and demodulated to recover approximate algebraic coefficients, referred to here as received identities coefficients 1216. Using the shared secret key 1250, the receiver regenerates the expected coefficients 1216 associated with the originally transmitted identities. The received coefficients may then be passed through an optional correction module 1218, which utilizes several parametric models: a channel model 1260 to estimate physical-layer distortions, a Level-A modulation model 1270 to account for encoding-specific artifacts (e.g., AM, FM, OFDM), and a Level-B structural alteration model 1280 to infer or compensate for secondary modulations applied by the transmitter. These models jointly inform the receiver's optimization process and enable the system to recover both the semantic content, and any side-channel information encoded through modulation.

In one embodiment, the receiver 1200 uses the parametric models referenced above to compute corrected coefficients zzz_k. The raw demodulated coefficients zz_k and shared due to seed sharing coefficients x_i and y_j are adjusted using a metric matrix [Ro]=[ro_ij], which models signal distortions (per frequency amplitude and phase changes) on a per-element basis, and a clock drift parameter τ, which accounts for phase drift across frequency bands. Each zz_k is corrected as: zzz_k=zz_k*exp (i*τ*f_k/f_1). The complete received identity is reconstructed as sum over

$$i , j of ( ro\_ij * x\_i * y\_j * ( e\_i * e\_j ) ) = sum over k of ( zzz\_k * e\_k ) .$$

To jointly infer the transmitted group algebra structure and the distortion effects applied by the channel, the receiver defines an objective function L. This function is based on a system of reconstructed algebraic identities, using corrected coefficients zzz_k on the right-hand side and coefficients x_i, y_j on the left. The objective function is defined as:

$$L ( Ro , τ , \{ e\_i \} ) = \sum \_identities {‖ \sum \_ \{ i , j \} ( ro\_ij ⋆ x\_i * y\_j * ( e\_i * e\_j ) ) - \sum \_k ( zzz\_k * e\_k ) ‖}^{2}$$

The objective function L is minimized with respect to a set of unknown parameters: the group elements e_i (represented numerically), the distortion matrix entries ro_ij, and the clock drift parameter τ.

If the optimization converges to a solution in which some of the group elements e_i are flipped in sign, the system constructs an extended candidate set {e_1, . . . , e_n, −e_1, . . . , −e_n} and derives a corresponding group Q. A factor group Q/Z₂ is then constructed to resolve this symmetry and considered as the valid multiplication table. Once the correct group structure is inferred, the receiver may enter a tightening stage, during which the group elements e_i are held constant (numeric or symbolic) and the optimization is rerun to refine estimates of the distortion matrix ro_ij and clock drift τ. This allows precise recovery of: amplitude attenuation and phase shift per frequency component, statistical variance in distortion estimates, and residual timing misalignment.

If intersymbol interference (ISI) is present, the receiver extends its model to account for contributions from adjacent identity segments. In this case, the identity reconstructed for time segment (u+1) is expressed as:

$$\sum \_ \{ i , j \} [ h * ro\_ij * x\_i ( u ) * y\_j ( u ) + ro\_ij * x\_i ( u + 1 ) * y\_j ( u + 1 ) ] * ( e\_i * e\_j ) = \sum \_k zzz\_k ( u + 1 ) * e\_k$$

where h is a learned coefficient representing the ISI influence. This extended model is incorporated into the objective function and jointly optimized along with the other parameters. If ISI covers more than one time step, the model can be extended in analogous manner.

The corrected coefficients, together with the known coefficients and algebraic structure, form a system of approximate identities 1219, which serve as input to an objective function module 1400. This module computes a identities residuals error 1410, quantifying how closely the left- and right-hand sides of the identities agree under the current numerical approximation of group elements and distortion parameters.

To enhance robustness and preserve structural fidelity, a group regularization module 1420 is used. It receives inputs from the candidate set of numeric representations of group elements 1425, and enforces algebraic constraints such as associativity and constraints imposed on irreducible representations by great orthogonality theorem. These constraints ensure stability of convergence and compliance with properties of a valid group algebra.

The objective function module 1400, reconstruction error 1410, and group regularization 1420 all interface with an optimization subsystem 1430, which executes the joint optimization process. This subsystem iteratively refines the decoding by minimizing reconstruction error while maintaining algebraic consistency, ultimately yielding the semantic structure originally transmitted.

In some embodiments, the receiver further infers additional sets of unknown quantities 1245 and 1246, representing latent parameters of the channel or environmental characteristics. These parameters enable the system to function not only as a decoder but also as an integrated sensing platform, allowing it to extract information about channel ISI profile, frequency-selective fading, phase shifts, clock drift, or other external conditions without requiring explicit calibration signals.

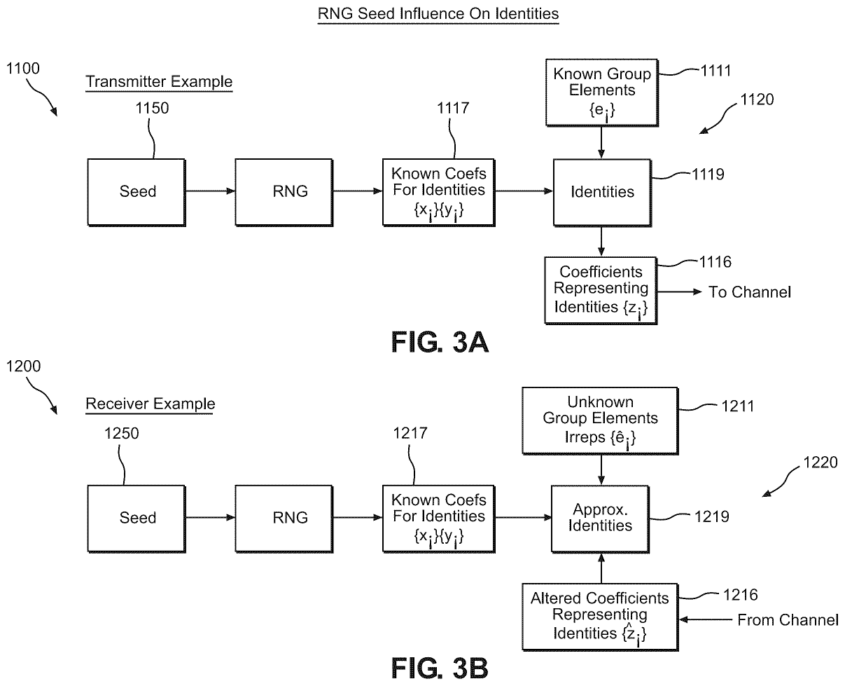

Referring now to FIGS. 3a and 3b, there is shown a diagram of an embodiment illustrating how a secret key or random number generator (RNG) seed influences the generation and decoding of algebraic identities on both the transmitter and receiver sides of the structural communication system.

On the transmitter side 1100, a secret key input 1150 seeds a random number generator (RNG), which produces a deterministic sequence of coefficients 1117. These coefficients correspond to algebraic identities 1119 composed using known group elements 1111 and multiplication table from a selected for transmission group algebra. The identities form a representation of the Level-B signal. The numerical coefficients (e.g., real or complex values) define the linear combinations used in identity formation, which are then passed to the signal modulator 1120 for transformation into a Level-A signal suitable for physical transmission over the communication channel 1300.

This embodiment demonstrates a secure and flexible encoding process in which the same semantic content can yield many distinct Level-A representations, depending on the chosen secret key. The system leverages properties of variability and invariance: different algebraic identities may represent the same information, yet preserve enough structure for robust decoding. This architecture also enhances security, as the transmitted structural forms appear unstructured or unpredictable to external observers, preventing the collection of training data for machine learning-based attacks.

On the receiver side 1200, a matching secret key 1250 seeds a synchronized RNG, generating a corresponding set of known coefficients 1217 that match those used at the transmitter. These coefficients define the expected form of the transmitted identities and contribute to a set of approximate algebraic identities 1219 reconstructed from two sources:
(1) the altered coefficients 1216 recovered from the received Level-A signal, and
(2) the unknown group elements 1211 inferred from the decoding optimization process.

An optional correction module 1218 may further refine the recovered coefficients using side models—such as a modulation model or a structural alteration model—previously described with respect to FIG. 1. The receiver then tune the parameters of these models jointly with others.

In some embodiments, the transmitter or receiver need not be a conventional electronic device. For example, a human speaker may function as the transmitter by producing audio patterns corresponding to structured signals, and a device-based recognizer may decode the structure. Conversely, a device synthesizer may encode structural information in visual, audio, or haptic form for interpretation by a human receiver. This flexibility highlights the broad applicability of the system across human-machine and machine-machine communication scenarios.

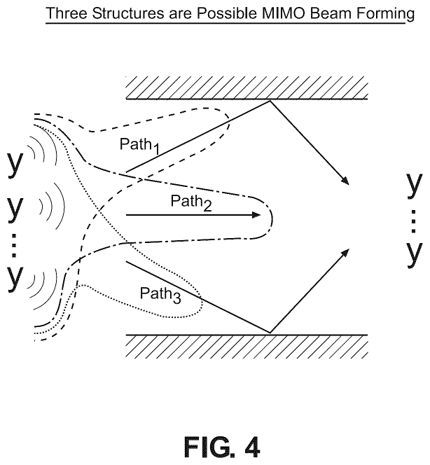

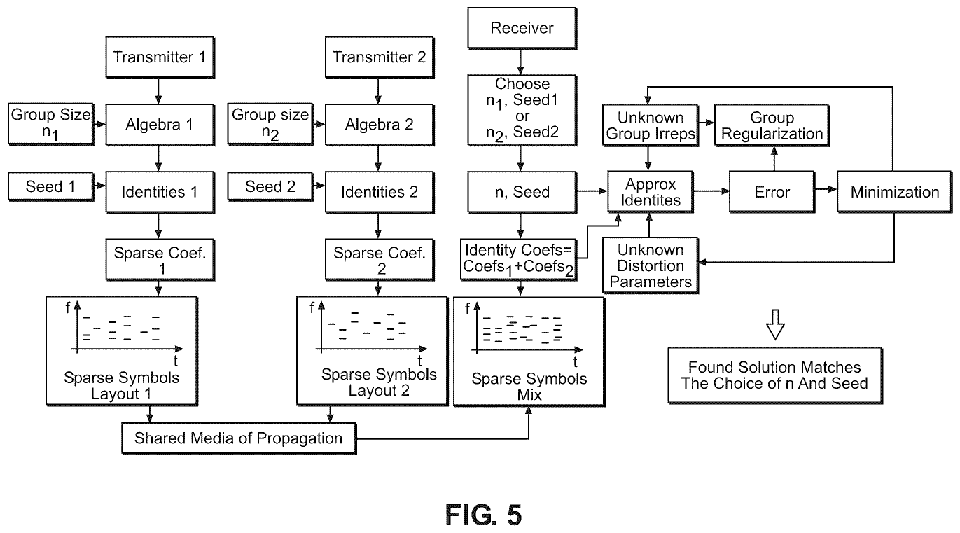

Referring now to FIGS. 4 and 5, a diagram illustrates an embodiment for multiplexed transmission of structured signals in a shared communication channel and means of disambiguation on the receiver side. This embodiment enables simultaneous transmission of multiple structured signals within the same spectral or spatial communication channel, extending the arsenal of known separation techniques (by frequency bands, time slots, or orthogonal coding). Each structured signal is defined by a distinct Level-B representation (PGAMT), and thus occupies a different algebraic identity space. Because the decoder distinguishes signals based on their internal algebraic consistency rather than waveform separation, the system supports parallel transmission of semantically distinct messages even in overlapping or interference-prone environments. This structure-based multiplexing technique permits asynchronous communication across shared bandwidth or shared medium conditions, and allows signal streams to be disentangled by their semantic form rather than their spectral signature. From the perspective of MIMO-like systems (FIG. 4), this approach enables intelligent reception akin to beamforming, where the receiver can “focus” its decoding on specific structured streams. The embedded algebraic structure provides natural separability, allowing the receiver to discard signals that violate structural integrity, recognize expected algebraic signatures, and recover the intended message stream.

FIG. 5 further illustrates a system configured for such shared media structural communication, detailing specific mechanisms for enhanced source separation. As depicted in FIG. 5, multiple transmitters (e.g., Transmitter 1, Transmitter 2) can operate concurrently, sending their respective Level-B signals. Each transmitter may use a unique transmission scheme, for instance, by employing a distinct group algebra (differentiated by size or structure) or a unique secret key (e.g., seed1 for Transmitter 1, seed2 for Transmitter 2) for generating its system of algebraic identities. These Level-A signals, representing the distinct Level-B structures, are transmitted over a shared physical medium where they may intermix.

In one embodiment, a receiver aiming to decode information from a particular transmitter (e.g., Transmitter 1) is configured with that transmitter's specific transmission scheme parameters (e.g., its group size and secret key). This configuration allows the receiver to determine the expected characteristics of the algebraic identities from the targeted transmitter. When processing the mixed signal from the shared medium, the receiver's decoder attempts to identify an algebraic structure that consistently satisfies these expected identities. This process enables the receiver to selectively isolate and decode the signal from Transmitter 1, effectively filtering out or mitigating interference from other signals (e.g., from Transmitter 2) due to their different underlying algebraic structures or identity generation schemes.

The system also enables simultaneous extraction of semantic information and channel or environmental characteristics from the signals received in such a multiplexed environment. As each structured signal is decoded, observed distortions can be interpreted to infer properties of the communication environment, such as multipath profiles, frequency-selective fading, or temporal drift. In the case of a visual medium selected for Level-A signals, identifiable distortions may include color correction or various geometric distortions. The algebraic structure itself thus serves as a carrier for both primary message content and channel state information, enabling the system to function as a combined semantic communication framework and an integrated sensing mechanism without needing dedicated pilot signals.

This embodiment enables simultaneous transmission of multiple structured signals within the same spectral or spatial communication channel, extending arsenal of known separation techniques (by frequency bands, time slots, or orthogonal coding). Each structured signal is defined by a distinct Level-B representation, and thus occupies a different algebraic identity space. Because the decoder distinguishes signals based on their internal algebraic consistency rather than waveform separation, the system supports parallel transmission of semantically distinct messages even in overlapping or interference-prone environments. This structure-based multiplexing technique permits asynchronous communication across shared bandwidth or shared medium conditions, and allows signal streams to be disentangled by their semantic form rather than their spectral signature

From the perspective of MIMO-like systems, this approach enables intelligent reception akin to beamforming, where the receiver can “focus” its decoding on specific structured streams. the embedded algebraic structure provides natural separability, allowing the receiver to discard signals that violate structural integrity, recognize expected algebraic signatures, and recover the intended message stream.

The system also enables simultaneous extraction of semantic information and channel or environmental characteristics. As each structured signal is decoded independently, the observed distortions—such as variations in phase, amplitude, or group element interactions—can be interpreted to infer properties of the communication environment. These may include multipath and ISI profiles, frequency-selective fading, or temporal drift. In case of visual medium selected for Level-A signals, the identifiable distortions may include color correction, projective geometry distortions, lens non-linear distortions, etc. The algebraic structure itself serves as a carrier not only of primary message content, but also of channel state information, enabling the system to function as both a semantic communication framework and a sensing mechanism integrated into the signal structure, without requiring dedicated pilot sequences or calibration probes.

The use of algebraic identities and their optional dependency on an RNG supports the properties of variability and invariance. The same message (group algebra) can be transmitted using multiple identity forms and coefficients (variability), and the receiver can recognize equivalent semantic content regardless of the specific encoding (invariance).

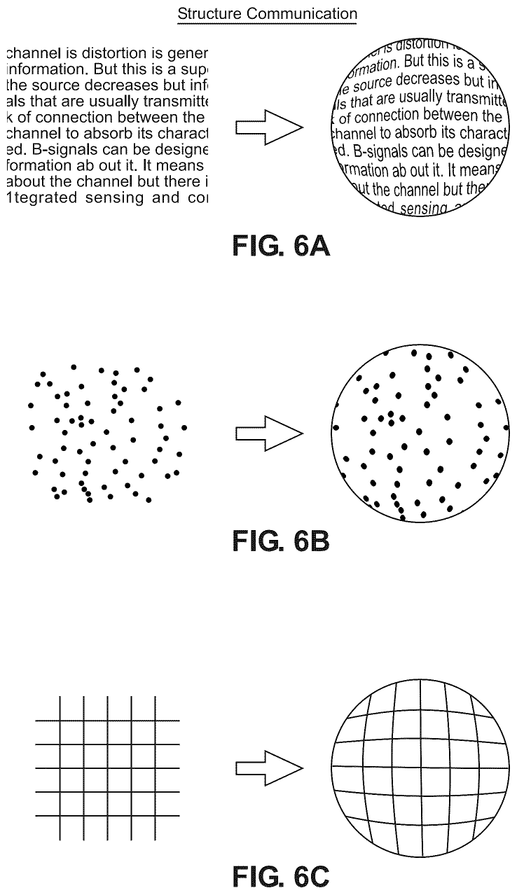

Referring now to FIGS. 6a, 6b, and 6c, there are shown visual illustrations of an embodiment demonstrating the resilience and interpretability of structured communication signals under conditions of signal distortion. Three comparative examples are depicted. In the first, a structured element—such as a text or symbolic pattern—is passed through a distortion field (e.g., a simulated lens), which alters its geometric properties but retains its recognizable form. In the second, a set of unstructured points undergoes the same distortion, resulting in ambiguity, dispersion, and loss of meaningful correspondence. In the third, a structured graphical or relational object (such as a calibration or pilot signal) is deformed yet remains semantically coherent due to its embedded organizational constraints.

This figure visually demonstrates the operation of the disclosed system, in which signals are encoded not merely as raw amplitude or frequency components, but as Level-B algebraic structures. These structured signals possess internal consistency and semantic relationships that persist even when the physical signal is subjected to nonlinear transformations—such as multipath, distortion, lensing, or scattering. Unlike unstructured signal formats, the structured representations enable not only semantic recovery, but also inference of the channel-induced transformation, based on deviations from known structural patterns.

This structural robustness enables a joint decoding process, in which both the original semantic message and properties of the channel distortion are recovered together, without requiring calibration sequences or pilot tones. In one interpretation, the receiver perceives not only the deformed signal but can also estimate the nature of the deformation-analogous to how a human infers lens curvature from distorted text. This demonstrates the system's capacity for simultaneous semantic recovery and environment-aware signal interpretation.

Furthermore, the structure itself may be modulated intentionally, such as by varying the spatial arrangement, orientation, or relative scaling of elements within the signal. These controlled alterations encode additional information without compromising the recoverability of the core semantic content. The system thus supports multiple modes of communication: direct transmission of symbolic structure (e.g., as in text), inference of transmission conditions via Level-A deformation analysis, and secondary information channels through Level-A and Level-B structure modulation.

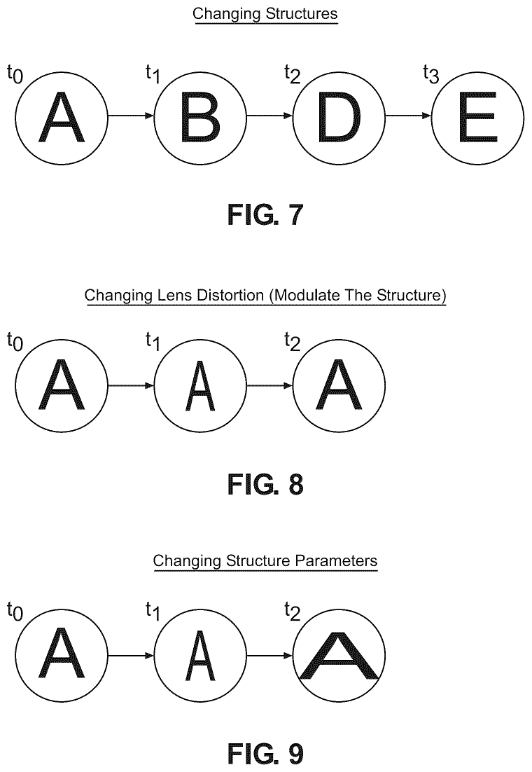

Referring now to FIG. 7, there is shown a diagram of an embodiment in which data is encoded through temporal switching between different algebraic structures. The illustration depicts a sequence of representations labeled A, B, D, and E appearing at discrete time intervals t₀, t₁, t₂, and t₃. Each representation corresponds to a distinct group algebra or structural configuration within the Level-B signal space.

The transmitter in this embodiment selects and activates one structure at a time from a predefined family of group algebras, each characterized by a unique multiplication rule and elements enumeration. The family can be a relatively small library representing an alphabet used for communication. In this case transmitter and receiver encode and decode data to and from this alphabet and get benefits of reliability, integrity awareness, increased multiplexing capacity, source separation, robustness to distortions and noise. The family can also span over whole set of multiplication tables for a given group size and this can reach billions of billions of structures and still provide same set of benefits.

Referring now to FIG. 8, there is shown a diagram of an embodiment in which information is encoded by applying controlled distortions to a fixed algebraic structure. Across times t₀, t₁, and t₂, the same underlying structure (Structure A) is maintained, but the representation changes through progressively varied distortions. These distortions may take the form of parameterized deformations, nonlinear mappings, or modulation of numerical coefficients representing algebraic identities. Importantly, the distortions are not random. They are introduced systematically and with precision, allowing them to carry secondary information or side-channel data. The receiver, equipped with a model of the alteration process, is configured to recognize the underlying structure despite the distortion, and to recover both the primary structured representation and the secondary information encoded in the modulation.

FIG. 9 shows a diagram of an embodiment in which information is encoded through variations of internal parameters of a single structure. The figure depicts Structure A at time t₀, followed by altered versions such as a “skinny A” at time t₁ and a “fat A” at time t₂′. While the overall identity of the structure remains consistent, its parameters, such as weighting, spacing, or geometric scaling, are adjusted. An embodiment can implement this behavior via deliberate modulation and demodulation of Ro matrix coefficients that define the multiplication operation itself.

These parameter variations are applied in a way that preserves the algebraic constraints of the structure, ensuring that the signal remains recognizable and decodable. However, the specific configuration of these parameters conveys additional information. If structure itself defines “what” is transferred, then this secondary type of information defines “style” or “flavor” of it. If accepting human speech metaphor, there is always “what” is uttered (structure) and “how” or “who” uttered it (voice specifics). In context of machine-machine communication, this second channel can be used to add individual “voice” characteristics to a machine instance. From purely technical perspectives this should be understood as just another channel that may include: Encoded secondary content, Contextual signals, Configuration instructions, or Environmental metadata. The receiver detects both the stable structure and the specific variation applied at each chunk of identities by jointly optimizing for all unknowns. Therefore, this enables expressive yet resilient encoding.

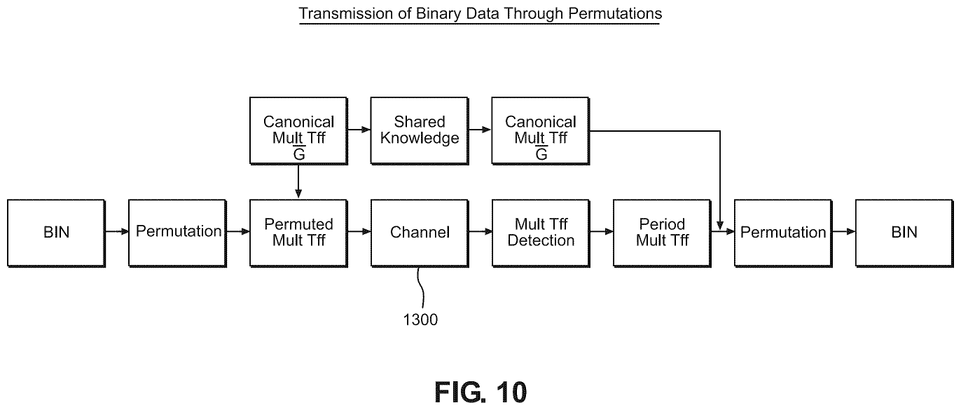

Referring now to FIG. 10, there is shown a flowchart of an embodiment illustrating the transmission and recovery of binary data through group algebra-based structural encoding. This embodiment demonstrates how discrete binary information is mapped to permutations of a canonical group multiplication table, transmitted across a channel, and decoded at the receiver using shared group-theoretic knowledge.

At the transmitter side 1100, the process begins with a binary input stream labeled “BIN.” This data is converted into a sequence of permutations, each corresponding to a reordering of elements in a known canonical group multiplication table G. Each permutation results in a permuted multiplication table. This process is deterministic and reversible: given the reference table and the permuted table, the permutation and then the binary data can be uniquely reconstructed. Each resulting permuted multiplication table serves as a Level-B structured representation of the original binary data. These tables define the structure of the group algebra itself. The canonical group multiplication table G is stored as a shared reference 1115 between transmitter and receiver, and all permutations are defined relative to this base.

In one embodiment, the permuted table is then used to form algebraic identities that are transmitted over the physical communication channel 1300 according to FIG. 2, where it may be subjected to noise, interference, distortion, or nonlinear transformations.

At the receiver side 1200, the incoming signal is demodulated, and the system invokes structural optimization techniques (such as those shown in FIG. 1) to recover the most likely transmitted multiplication table. Using the shared canonical table G and the identified multiplication table, the receiver infers the permutation applied at the transmitter. This recovered permutation is then decoded back into binary form, reconstructing the original input stream. The space of possible permutations is combinatorially large, enabling convenient encoding of data into structural form, enabling all the mentioned earlier advantages of structure-aware transmission layers (integrity awareness, error correction, easily controllable redundancy, security, ML attacks impossibility, noise and distortions robustness, source separation, asynchronous possibly overlapping transmissions, integrated sensing, and others). By using group algebra representations as transport layers for binary data, this bridges the gap between conventional digital communication and semantic structural encoding, supporting downstream applications in learning, recognition, synthesis, and structure-aware processing.

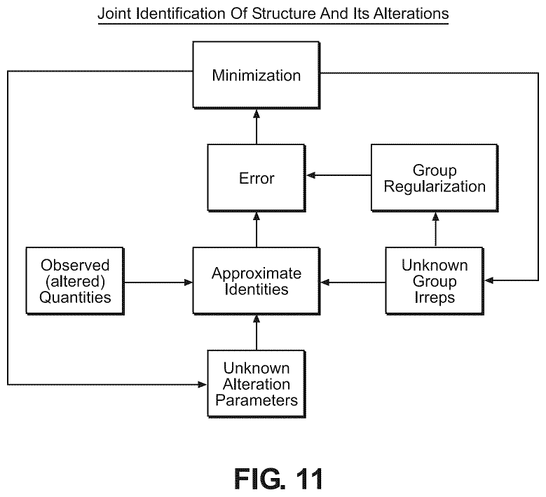

Referring now to FIG. 11, there is shown a diagram for the joint identification of an algebraic structure and its alterations, as performed by the receiver subsystem 1200 (FIG. 2). This process embodies the two-directional flow of information, where bottom-up observed data and top-down structural constraints are reconciled. The process begins with “observed (altered) quantities.” These are derived from the received Level-A signal after initial processing by the signal input interface 1201 (FIG. 2), representing the potentially distorted or modulated numerical coefficients of the transmitted algebraic identities. These observed quantities, along with “unknown alteration parameters” (which model Level-A or Level-B modulations, or channel distortions), are used to form a system of “Approximate algebraic identities” 1219 (FIG. 2). These identities are “approximate” because the true group elements and the exact alteration parameters are initially unknown. The satisfaction of these approximate algebraic identities depends on the “unknown group elements” and the aforementioned unknown alteration parameters.

An “error” metric, related to the identity residuals error 1410 in FIG. 2, is computed, quantifying how well the current estimates of the unknown group elements and alteration parameters satisfy the system of approximate algebraic identities. This error forms the basis of an objective function L. A “minimization” process, corresponding to the optimization subsystem 1430 in FIG. 2, is then employed. This optimization iteratively adjusts the unknown group elements (irreps) and the unknown alteration parameters with the goal of minimizing the error.

To ensure that the identified “unknown group elements (irreps)” correspond to a valid and consistent algebraic structure, group regularization techniques, which can be performed by module 1420, are applied. These enforce algebraic constraints (e.g., associativity, properties of a valid multiplication table) on the estimates of the group elements, guiding the minimization process towards a structurally sound solution. The output of group regularization also influences the error computation. Through this iterative process of forming approximate identities, measuring error, and performing constrained minimization, the receiver jointly determines the underlying Permuted Group Algebra Multiplication Table (PGAMT) and the parameters of any alterations, effectively decoding the transmitted information and characterizing distortions or modulations.

It is therefore submitted that the instant invention has been shown and described in what is considered to be the most practical and preferred embodiments. It is recognized, however, that departures may be made within the scope of the invention and that obvious modifications will occur to a person skilled in the art.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A transmitter device for communicating structured information, comprising:
an encoder configured to convert input data into a Level-B signal comprising one or more elements of a selected group algebra, each element defined according to an algebraic multiplication rule specified by the group algebra; and
a signal modulator operatively coupled to the encoder, configured to map the Level-B signal to a corresponding Level-A signal suitable for transmission over a physical communication channel.

2. The transmitter device of claim 1, wherein the modulator is further configured to represent Level-B signal using numerical coefficients, real or complex, associated with algebraic identities satisfiable within the group algebra.

3. The transmitter device of claim 2, wherein the algebraic identities and the numerical coefficients are determined based on a secret key controlling a random number generator (RNG) seed or according to a predefined fixed scheme.

4. The transmitter device of claim 1, wherein the Level-B signal is a predetermined algebraic structure, and the corresponding Level-A signal, when transmitted through the physical communication channel, exhibits variations indicative of characteristics or distortions of said channel.

5. The transmitter device of claim 1, wherein the modulator is configured to vary the selection of the algebraic identities based on a secret key, such that the same input data is encodable into multiple distinct Level-A representations.

6. The transmitter device of claim 1, wherein the signal modulator is configured to apply a controlled distortion or modulation to the Level-A signal, wherein the controlled distortion encodes secondary information distinct from the input data.

7. The transmitter device of claim 1, wherein the selected group algebra comprises a finite abelian group algebra.

8. The transmitter device of claim 1, wherein the encoder, in converting input data into the Level-B representation, is configured to generate a Permuted Group Algebra Multiplication Table (PGAMT) that uniquely corresponds to the input data.

9. The transmitter device of claim 1, wherein the controlled distortion comprises a modulation of algebraic structure characteristics, wherein the secondary information is embedded without degrading recoverability of the original Level-B signal.

10. The transmitter device of claim 9, wherein the modulation of algebraic structure characteristics comprises modifying the group multiplication operation using an Ro matrix having numeric coefficients that encode the secondary information.

11. The transmitter device of claim 1, wherein the generative artificial intelligence model comprises at least one of a variational autoencoder (VAE), denoising autoencoders, transformer-based models, or a diffusion model configured to synthesize representations optimized for transmission through the physical communication channel.

12. The transmitter device of claim 1, wherein the Level-A signal comprises a modulated set of carrier frequencies, each carrier frequency corresponding to a numerical coefficient associated with a basis element of the group algebra.

13. The transmitter device of claim 1, wherein the signal modulator implements channel modulation by means of a generative artificial intelligence model configured to:
initialize latent variables of the generative model with numerical coefficients representing an algebraic identity; and
generate the Level-A signal by executing a forward pass of the generative model.

14. A receiver device for decoding structured information from a received Level-A signal transmitted over a physical communication channel, comprising:
a decoder operatively coupled to a signal input, configured to:
identify the Permuted Group Algebra Multiplication Table (PGAMT) embedded within the received Level-A signal by evaluating algebraic identities satisfiable by the elements;
jointly determine modulation or distortion of the Level-A signal introduced during transmission over the channel and decode primary information encoded within the Level-B signal; and
jointly recover secondary information encoded via controlled variations or distortions applied to algebraic structure characteristics of the Level-B signal.

15. The receiver device of claim 14, wherein the decoder is further configured to receive multiple Level-A signals simultaneously transmitted over a shared communication medium, each Level-A signal representing distinct Level-B signal defined by different group algebra structures or distinct transmission schemes, wherein the decoder is configured to isolate and decode the structured representation corresponding to a selected transmission scheme.

16. The receiver device of claim 14, wherein the decoder is further configured to extract environmental or channel characteristics from variations or distortions detected in the received Level-A signal, thereby providing integrated communication and sensing functionality without requiring dedicated pilot or calibration signals.

17. The receiver device of claim 14, wherein the decoder is further configured to decode Level-A signals using orthogonal frequency-division multiplexing (OFDM), frequency-shift keying (FSK), amplitude-shift keying (ASK), phase-shift keying (PSK), or quadrature amplitude modulation (QAM), wherein the modulation controls coefficients associated with basis elements of the group algebra.

18. The receiver device of claim 14, wherein the decoder is configured to decode signals modulated with controlled algebraic distortions applied at the transmitter, wherein the distortions encode secondary data without impairing recovery of primary Level-B structured information.

19. The receiver device of claim 14, wherein the decoder further comprises a parametrized demodulation component configured to convert the received Level-A signal into coefficients representing the algebraic identities, and wherein parameters of the demodulation component are jointly determined with the group algebra structure.

20. The receiver device of claim 14, wherein the decoder is further configured to convert the identified group algebra structure, and any recovered secondary information from Level-A or Level-B modulations, into an original data format of the input data.

21. The receiver device of claim 14, wherein the decoder is further configured to decode Level-A signals using neural net models, wherein the resulting latent variables, extracted features, or class probabilities are associated with identity coefficients.
